(19) United States
(12) Patent Application Publication
(10) Pub. No.: US 2004/0060612 A1
(43) Pub. Date: Apr. 1, 2004

(54) Fuel nozzle drip retainer

(76) Inventor: Curtis E. Dame, Kalamazoo, MI (US)

Correspondence Address: Richard C. Litman, LITMAN LAW OFFICES, LTD., P.O. Box 15035, Arlington, VA, 22215, US

(21) Appl. No.: 10/179,306

(22) Filed: Jun. 26, 2002

(51) Int. Cl. B65B 3/04; B67C 3/02; B65B 1/04

(52) U.S. Cl. 141/86

(57) ABSTRACT

The present invention is a drip retainer for liquid dispensers, such as fuel pumps. The device itself has a semicylindrical body adapted for insertion into the nozzle of a fuel dispenser pump. The semicylindrical body is open at the inflow end and has a crescent-shaped lip for restricting fluid flow at the outflow end. The retainer gradually increases in thickness from the inflow end to the outflow end, forming a ramp up to the crescent-shaped lip. The retainer has a slightly smaller radius of curvature at the inflow end than at the outflow end, so that the retainer is inserted into the nozzle, inflow end first, and forms a press fit or friction fit in the nozzle. Fuel under pressure passes over the crescent shaped lip. When the nozzle is shut off, any residual fuel trickling through the nozzle is stopped by the crescent-shaped lip.

### BACKGROUND OF THE INVENTION

1. Field of the Invention

The present invention relates to fluid dispensing devices, in particular, to a fuel nozzle drip retainer for preventing unwanted dripping or spillage of fuel from the nozzle of a fuel pump.

2. Description of the Related Art

A common complaint among commuters and pleasure travelers alike is the tendency for filling station fuel pump nozzles to leak fuel after the nozzle has been removed from the fuel filler port of an automobile. Even with the addition of vapor trapping collars on the fuel nozzles which prevent fuel vapors from entering the surrounding air, the nozzles still drip fuel when the nozzle is removed. Fuel dripping from the nozzle will often stain the automobile's paint job, requiring the car to be washed, and exposes volatile hydrocarbons to the atmosphere, which is a matter of environmental concern. Consequently, several attempts have been made in the past to prevent pumps from dripping fuel after the flow of liquid has been stopped, but there has been little success, prior to the present invention.

U.S. Pat. No. 3,923,425 issued to David L. Porter et al. on Dec. 2, 1975, shows a fuel pump shut-off valve installed on an automobile. The fuel pump valve uses positive pressure across a diaphragm member to force an inlet/shut-off valve into a closed position.

U.S. Pat. No. 4,846,836 issued to Jonathan D. Reich on Jul. 11, 1989, shows a bi-directional valve which can be inserted into the gastroesophageal sphincter to provide a pressure differential artificial valve.

U.S. Pat. No. 5,377,729 issued to Alan J. Reep on Jan. 3, 1995, shows a spring-biased plug member mounted at the end of a fuel nozzle which prevents liquid such as gasoline from dripping or escaping out the dispensing end of the nozzle when liquid is not being dispensed through the nozzle.

U.S. Pat. No. 5,620,032, issued to the present inventor on Apr. 15, 1997, shows a gas nozzle valve having an expandable integral wire frame made from two spaced interconnected springs. This invention differs from the current invention in that the current invention has no moving parts or frame, and is more economical to manufacture.

British Patent No. 228,306, published on Feb. 5, 1925, shows a fuel pump nozzle with a spring-biased, central poppet valve placed at the end of a fuel nozzle to prevent fuel from dripping after the main flow has stopped.

British Patent No. 1,027,271, published on Apr. 27, 1966, shows a mechanically operated poppet valve centrally located within a fuel dispensing nozzle. Side protruding tabs are displaced by the throat of the fuel filler pipe during insertion of the fuel nozzle into the automobile to allow the central poppet valve to become unseated under fuel flow pressure allowing fuel to flow past the nozzle. When the fuel flow is terminated, the poppet valve reseats and seals the nozzle against drippage.

None of the above inventions and patents, taken either singly or in combination, is seen to describe the instant invention as claimed. Thus a fuel nozzle drip retainer solving the aforementioned problems is desired.

### SUMMARY OF THE INVENTION

The present invention is a drip retainer for liquid dispensers, such as fuel pumps. The device itself has a semicylindrical body adapted for insertion into the nozzle of a fuel dispenser pump. The semicylindrical body is open at the inflow end and has a crescent-shaped lip for restricting fluid flow at the outflow end. The retainer gradually increases in thickness from the inflow end to the outflow end, forming a ramp up to the crescent-shaped lip. The retainer has a slightly smaller radius of curvature at the inflow end than at the outflow end, so that the retainer is inserted into the nozzle, inflow end first, and forms a press fit or friction fit in the nozzle. Fuel under pressure passes over the crescent shaped lip. When the nozzle is shut off, any residual fuel trickling through the nozzle is stopped by the crescent-shaped lip.

The invention functions as a baffle inside a pump nozzle. When liquids are pumped from the nozzle the sloping inner surface of the invention does little to impede the flow of the liquid. When pumping is complete the invention functions to block the small amount of liquid remaining in the pump from exiting the nozzle. In this way noxious liquids such as gasoline can be prevented from dripping out of a nozzle after pumping and polluting the environment and/or staining shoes, clothing, or the surface of the vehicle.

Accordingly, it is a principal object of the invention to provide a fuel nozzle drip retainer which prevents a fuel nozzle from dripping excess fuel.

It is another object of the invention to provide a retainer that will prevent fuel from dripping from a nozzle that does not require adhesive, spring clips, or other devices for retention in the nozzle.

It is a further object of the invention to provide a device that will prevent air pollution resulting from fuel spillage.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental view showing a fuel dispensing nozzle broken away and partly in section to show a fuel nozzle drip retainer according to the present invention.

FIG. 2 is a perspective view showing the inner surface of the fuel nozzle drip retainer according to the present invention.

FIG. 3 is a side view of the fuel nozzle drip retainer according to the present invention.

FIG. 4 is a perspective view showing the outer surface of the fuel nozzle drip retainer according to the present invention.

Similar reference characters denote corresponding features consistently throughout the attached drawings.

### DETAILED DESCRIPTION OF THE PREFERRED EMBODIMENT

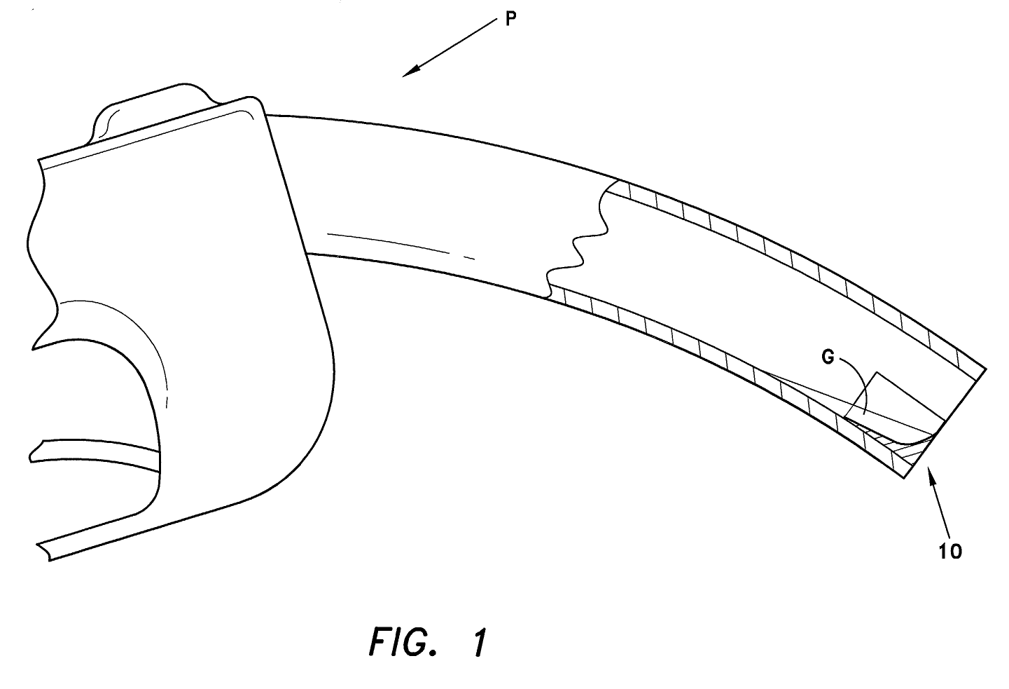

The present invention, as illustrated in FIG. 1 is a fuel nozzle drip retainer 10. The invention as shown is preferably inserted into the end of a fuel pump nozzle P and functions as a baffle that permits gasoline G or other liquids to flow from the nozzle P when pumping but then prevents residual fuel from leaving the nozzle P after pumping.

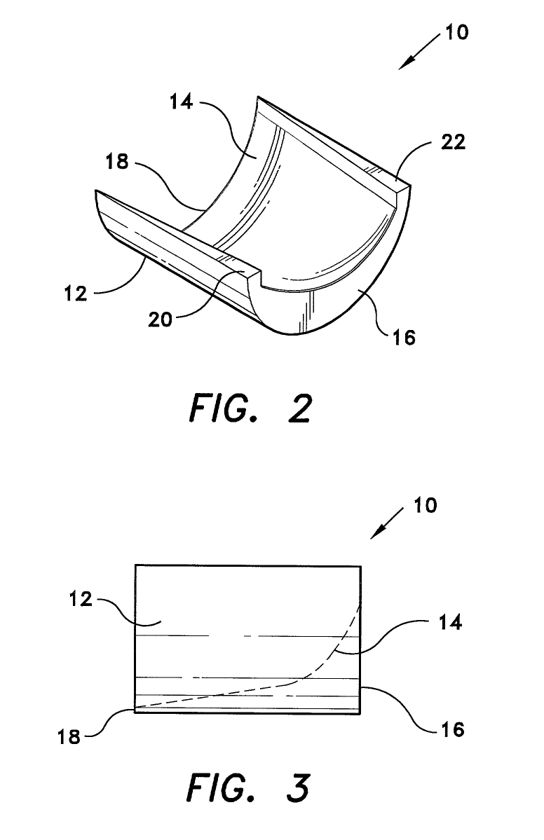

As illustrated in FIGS. 2, 3 and 4 the retainer 10 has a semicylindrical body with an arcuate outer surface 12, a sloping inner surface 14, a crescent-shaped lip 16 transverse to the body at the outflow end, and an inflow end 18. As can be seen by the two flat triangular top edges 20, 22 at the outflow end of the retainer 10, the body tapers in thickness from wide to narrow from the outflow end to the inflow end 18. As seen most clearly from the phantom line in FIG. 3, and as can be seen in the sectional view of FIG. 1, the inner surface slopes upward from the inflow end 18 to form a ramp approaching the crescent-shaped lip 18 at the outflow end of the retainer 10. Thus, instead of causing turbulence as fuel is pumped through the nozzle P, fuel flows smoothly up and over the ramp. When the pump is shut off, however, any residual fuel trickling down the nozzle P is stopped by the is crescent-shaped lip 16 and the small reservoir formed thereby.

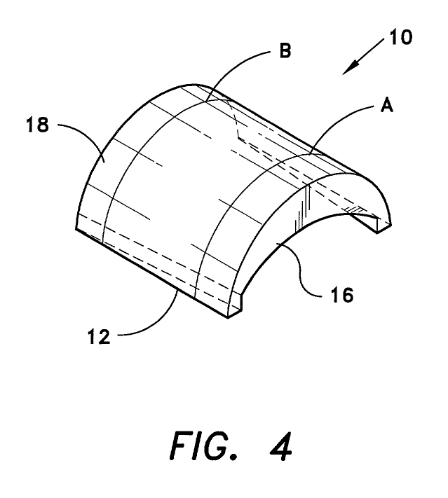

FIG. 4 illustrates the outer surface 12 of the invention 10. The radius of curvature of the outer surface 12 at the outflow end of the retainer 10, as indicated by the arc B, is slightly greater than the radius of curvature at the inflow end 18 of the retainer, as indicated by the arc A. The radius of curvature at A is sized and configured to be slightly smaller than the radius of curvature of the open end of the nozzle P, while the radius of curvature at B is slightly greater than the radius of curvature of the open end of the nozzle P. The retainer 10 is inserted into the nozzle P, inflow end 18 first, and pushed into the nozzle P, the outflow end being slightly compressed in passing into the nozzle P. The retainer 10 snaps into place, forming a press fit or friction fit against the wall of the nozzle P.

The retainer 10 is made in a single mold from a petroleum resistant polymer.

It is to be understood that the present invention is not limited to the embodiment described above, but encompasses any and all embodiments within the scope of the following claims.

I claim:

1. A fuel nozzle drip retainer, comprising:
a semicylindrical body having an open inflow end and an outflow end; and
a crescent-shaped lip transverse to said body at the outflow end of said body, said body being dimensioned and configured for forming a press fit against an inner surface of a fuel dispensing nozzle.

2. The fuel nozzle drip retainer as in claim 1, wherein said semicylindrical body increases in thickness from said inflow end to said outflow end.

3. The fuel nozzle drip retainer as in claim 2, wherein said body has an outer surface and an inner surface, said inner surface tapering upward from the inflow end to the outflow end, forming a ramp sloping up to said crescent-shaped lip.

4. The fuel nozzle drip retainer as in claim 1, wherein the inflow end of said body has a radius or curvature slightly smaller than the outflow end, the inflow end being dimensioned and configured for insertion into a fuel dispensing nozzle, the outflow end being compressed during insertion into the nozzle and forming a press fit against an inner surface of the nozzle.

5. The fuel nozzle drip retainer according to claim 1, wherein said body and said lip are made in a single piece from a petroleum resistant plastic material.

6. A drip free fuel nozzle, comprising:
(a) a fuel pump dispenser nozzle having an inner surface:
(b) a fuel nozzle drip retainer having:
(i) a semicylindrical body having an open inflow end and an outflow end; and
(ii) a crescent-shaped lip transverse to said body at the outflow end of said body, said body forming a press fit against the inner surface of said nozzle.

7. The drip free fuel nozzle as in claim 5, wherein said semicylindrical body increases in thickness from said inflow end to said outflow end.

8. The drip free fuel nozzle as in claim 6, wherein said body has an outer surface and an inner surface, said inner surface tapering upward from the inflow end to the outflow end, forming a ramp sloping up to said crescent-shaped lip.

9. The drip free fuel nozzle as in claim 6, wherein the inflow end of said body has a radius or curvature slightly smaller than the outflow end, the inflow end being dimensioned and configured for insertion into a fuel dispensing nozzle, the outflow end being compressed during insertion into the nozzle and forming a press fit against an inner surface of the nozzle.

10. The drip free fuel nozzle as in claim 6, wherein said body and said lip are made in a single piece from a petroleum resistant plastic material.
